(19) United States
(12) Patent Application Publication
(10) Pub. No.: US 2006/0168887 A1
(43) Pub. Date: Aug. 3, 2006

(54) Method for producing a fuel gas containing hydrogen for electrochemical cells and associated device

(76) Inventors: Frank Baumann, Mundelsheim (DE); Matthias Duisberg, Frankfurt (DE); Michael Lennartz, Frankfurt (DE)

Correspondence Address: KALOW & SPRINGUT LLP, 488 MADISON AVENUE, 19TH FLOOR, NEW YORK, NY, 10022, US

(21) Appl. No.: 10/535,605

(22) PCT Filed: Oct. 18, 2003
(86) PCT No.: PCT/EP03/12909

§ 371 Date: Feb. 2, 2006

(30) Foreign Application Priority Data
Nov. 19, 2002 (DE) 10253930.8

(51) Int. Cl. C10J 3/46; B01J 8/00

(52) U.S. Cl. 48/197 R; 48/127.9

(57) ABSTRACT

The invention relates to a process and an apparatus for producing hydrogen-containing fuel gases for fuel cells by catalytic reforming of hydrocarbons and subsequent gas purification. The process is characterized in that the catalytic reforming comprises two successive stages of which the first stage comprises autothermal reforming and the second stage comprises low-temperature steam reforming at temperatures below 650° C. In the first stage (autothermal reforming, ATR stage), a feed mixture of hydrocarbons, oxygen and water or water vapour is reacted over a catalyst in an autothermal reforming reaction to convert it incompletely into a hydrogen-rich gas mixture. The mixture which still contains residual amounts of hydrocarbons is then reacted in a subsequent steam reforming stage (second stage, SR stage) to give a hydrogen-rich fuel gas. A fuel gas which has a temperature at the reactor outlet of 400-650° C. and contains a very high proportion of hydrogen is obtained. Owing to the low outlet temperatures, the fuel gas can be passed directly to a gas purification stage without use of additional heat exchangers. In addition to the improvement in the reformer efficiency, a more compact and cheaper reformer design is made possible by the invention. Process and apparatus are used for producing hydrogen or hydrogen-containing fuel gases for fuel cells, in particular for mobile and stationary applications.

The present invention relates to a process for producing fuel gases for fuel cells. Here, a hydrogen-containing fuel gas is produced by reforming of hydro-carbons and is purified in further process steps. Furthermore, an apparatus for carrying out this process is described.

The process of the invention for producing hydrogen-containing fuel gases is based on a multistage reforming of hydrocarbons and a subsequent purification of the fuel gas by means of downstream reformate purification processes. These can, for example, be based on a water gas shift reaction (WGS reaction) or on a gas separation membrane.

The reforming of hydrocarbons according to the invention is a two-stage process and comprises an autothermal reforming and a downstream steam reforming. In the first stage, a feed mixture of hydrocarbons, air and water or water vapour is reacted over a catalyst in an autothermal reforming reaction to convert it incompletely into a hydrogen-rich gas mixture. This mixture, which still contains residual amounts of hydrocarbons, is then reformed in a subsequent steam reforming stage to give a hydrogen-rich fuel gas. A fuel gas which has a temperature at the reactor outlet of from 450 to 650° C. and contains a high proportion of hydrogen is obtained. The apparatus for reforming (the reactor) is constructed as a two-stage reactor, with a different catalyst being used in each stage. The fuel gas is subsequently subjected directly to further purification, for example in a water gas shift reactor or by means of gas separation membranes. Process and apparatus are used for producing hydrogen-containing fuel gases for fuel cells, in particular for mobile applications but also for stationary applications.

It is known that hydrogen can be produced by reacting hydrocarbons at elevated temperature in the presence of water vapour over a suitable catalyst to form hydrogen, carbon monoxide and carbon dioxide. This reaction, also referred to as “steam reforming” (SR), is strongly endothermic and proceeds, for example, according to the following reaction equation:
C₈H₁₈+8H₂O⇄8CO+17H₂ ΔH=+1250 kJ/mol (1)

A characteristic parameter for the steam reforming reaction (1) is the steam/carbon ratio S/C. In the reaction equation (1), S/C is equal to 1. Owing to the endothermic nature of this reaction, heat has to be supplied. However, if no heat is supplied (i.e. the reaction is carried out adiabatically), the reaction takes the heat required from the environment, so that a decrease in the temperature of the overall system occurs. This principle is utilized in the present invention.

A further known possible way of producing hydrogen is catalytic partial oxidation (CPO). Here, the hydro-carbons are reacted in the presence of oxygen over a catalyst according to the reaction equation for the partial oxidation (2) to form carbon monoxide and hydrogen:
C₈H₁₈+4O₂⇄8CO_{(g)}+9H₂ ΔH=−685 kJ/mol (2)

An important parameter for the partial oxidation is the air index λ, which is defined as the ratio of the number of moles of oxygen used to the number of moles of oxygen required for total oxidation [cf. reaction equation (3)]:
C₈H₁₈+12.5O₂⇄8CO₂+9H₂Oλ=1 ΔH=−5102 kJ/mol (3)

Complete conversion of the hydrocarbon into carbon monoxide and hydrogen in accordance with equation (3) requires an air index λ of <1, ideally λ=4/12.5=0.32.

Autothermal steam reforming (“autothermal reforming”, ATR) consists of two part processes. It combines the steam reforming of equation (1) with the catalytic, partial oxidation of equation (2), with the exothermic, partial oxidation supplying the heat of reaction necessary for the endothermic steam reforming. The feed mixture can be preheated to a preheating temperature. The product mixture is in thermodynamic equilibrium at the temperature prevailing at the reactor outlet. Autothermal reforming combines the advantages of the catalytic, partial oxidation (good starting behaviour) with those of steam reforming (high hydrogen yields) and is therefore preferably used for producing hydrogen in mobile fuel cell systems by means of on-board reforming. In the present patent application, autothermal reforming is regarded as a single process step despite the fact that it consists, as described, of two part processes.

EP 0 112 613 B1 describes a process for the autothermal reforming of hydrocarbons in which the partial oxidation occurs in zone 1 and steam reforming occurs physically separately therefrom in zone 2. The partial oxidation is carried out using Pt- and Pd-containing catalysts, and catalysts containing noble metals are used for steam reforming. A combination of autothermal reforming with a further subsequent steam reforming step is not described.

U.S. Pat. No. 4,415,484 discloses a catalyst for use in an autothermal reforming reactor. The catalyst comprises from 0.01 to 6% of rhodium and from 10 to 35% of calcium oxide on a support composed of aluminium oxide and magnesium oxide. According to this document, a typical catalyst system comprises an iron oxide catalyst for the partial oxidation over about one third of its length and the rhodium catalyst described over two thirds of its length.

EP 1 157 968 A1 describes a single-stage, adiabatically operated process for the autothermal catalytic steam reforming of hydrocarbons using a catalyst containing noble metals which has been applied to a support body. This catalyst catalyses both the partial oxidation and the steam reforming of hydrocarbons.

DE-A 199 55 892 A1 proposes a process for the reforming of hydrocarbons, in particular of diesel, which comprises a noncatalytic step and a catalytic step which take place physically and thermally separately from one another. In the first step, the hydrocarbon is sent through a burner nozzle and is partially burnt by means of a flame. The fuel gas mixture is subsequently catalytically reformed in the second step.

DE-A 197 27 841 A1 describes a process and an apparatus for the autothermal reforming of hydrocarbons, in which the fuel is introduced via a feed device into a two-stage reforming reactor. The resulting reformate is conveyed through a heat exchanger in countercurrent to starting materials of the reforming reaction conveyed from the outside inwards so that heat exchange occurs. The fuel fed in via the feed device is introduced together with the starting material directly into the catalyst-containing reaction zone in which combustion and reforming or catalysis are carried out. The reforming reactor contains a catalyst-coated honeycomb body in an upper region and a catalyst-coated bed in a lower region. It is also possible to use a honeycomb body in place of the bed.

DE-A 199 47 755 A1 discloses an autothermal reactor for reforming hydrocarbons, which comprises an endothermic reaction zone, an exothermic reaction zone and a downstream cooling zone (quench zone), with the latter being separated off by means of a gas-permeable heat shield. This reactor has a complicated construction and requires additional introduction of water into the quench zone and is therefore expensive, both to produce and in operation.

A fundamental disadvantage of the known processes for the autothermal reforming of hydrocarbons is the relatively high reaction temperature of 650-1000° C. Thus, a fuel gas mixture produced by autothermal reforming of petroleum spirit has a temperature of at least 650° C. at the gas outlet. The concentration of carbon monoxide in the reformate is in turn coupled to the outlet temperature via the thermodynamic equilibrium. Owing to the high temperatures, the fuel gas has a relatively high CO content and a low hydrogen content (typical fuel gases at 650° C. contain from about 28 to 36% by volume of hydrogen and from 10 to 15% by volume of carbon monoxide). The total hydrogen yield and, associated therewith, the efficiency of reforming is thus unsatisfactory. Finally, the overall efficiency of a fuel gas system (consisting of gas production and PEM stack) is thus also adversely affected. Relatively high hydrogen yields are therefore of critical importance and can be achieved, for example, by means of a reduction in the proportion of carbon monoxide in the fuel gas. However, the process temperatures for reforming have to be reduced to achieve this.

A further disadvantage of the existing processes is the fact that, as a result of the high fuel gas temperatures, expensive and bulky heat exchangers are additionally required in order to cool the fuel gas to the inlet temperatures of about 450° C. required for the subsequent purification processes. Apart from the higher costs for the heat exchangers and the greater space requirement, the additional waste heat also adversely affects the overall efficiency of the fuel gas production process.

It is an object of the present invention to provide an improved process and an improved apparatus for producing fuel gas for fuel cells. This object is achieved according to the invention by provision of the process according to Claim 1. Advantageous embodiments of processes and the apparatus for carrying them out are described in the subsequent claims.

According to the invention, a smaller space requirement, lower costs and a higher overall efficiency are advantageously achieved. In particular, a process for reforming hydrocarbons which makes it possible to reduce the fuel gas temperatures by about 200° C., for example from 650° C. to 450° C., is to be provided in a preferred embodiment. The hydrogen-containing fuel gas should be able to be passed directly, i.e. without additional cooling, to the subsequent purification stage(s), so that expensive and bulky heat exchanger systems are dispensed with.

The key part of the novel process for producing fuel gas is a two-stage reforming process. This process consists of the combination of autothermal reforming (which itself is made up of 2 stages, namely partial oxidation and steam reforming) with subsequent endothermic steam reforming of hydrocarbons. In the first reaction stage (ATR stage), a hydrogen-containing gas having a temperature above 650° C. is produced. The composition of this gas mixture is set so that it still contains 0.1-10% by volume of residual unreacted hydrocarbons. The temperature of the fuel gas is reduced to values below 450° C. by means of a subsequent second stage in which these residual hydrocarbons are reacted in an endothermic steam reforming reaction (SR stage) as a result of this second stage being carried out adiabatically.

The hydrogen yield is thereby increased in two ways: firstly by the further conversion in the steam reforming reaction in accordance with eq. (1) and secondly by the fact that as the temperature decreases, the equilibrium of the water gas shift reaction
CO+H₂O<=>CO₂+H₂ (4)
is moved to the right, i.e. to the side of hydrogen formation. Since the overall two-stage processes operated adiabatically (i.e. without heat being supplied from the outside), the hydrogen-containing fuel gas is cooled to temperatures of about 450° C. and can be passed directly, i.e. without additional heat exchangers, to the subsequent purification stages.

The proportions of residual hydrocarbons from 0.1 to 10% by volume necessary for steam reforming can be added to the gas mixture, for example through nozzles or injectors, before it enters the second stage. Suitable devices for this purpose are, inter alia, conventional injection nozzles as are used in motor vehicle engine technology. However, the proportions of hydrocarbons required can also be ensured in the form of unreacted residues (hydrocarbon “leakage”) by selection of specific parameters in the autothermal reforming. For example, the proportion of residual hydrocarbons can be controlled by means of a high space velocity (typically above 100 000 l/h); such high space velocities generally result in incomplete conversion of the hydrocarbons.

Furthermore, the residual hydrocarbons in the fuel gas which are necessary for the subsequent steam reforming can be ensured by construction measures on the reactor itself. This can be achieved, for example, by the use of monolithic catalyst supports having a cell density below 93 cells/cm² (600 cpsi) or by incorporation of additional flow channels which have a larger diameter than the remaining flow channels in the monolith. For example, a monolith having a low cell density of 62 cells/cm² (400 cpsi) can be used for the first stage (ATR), and a monolith having a high cell density of 186 cells/cm² (1200 cpsi) can be used for the second stage (SR).

The water necessary for steam reforming can be added separately or together with the hydrocarbon before the second stage. However, depending on the reaction conditions, the external addition of water is not necessary in many cases, since an appropriate excess of water can be added in the ATR process in the first stage.

The invention is explained in more detail below with reference to the appended drawings which show:

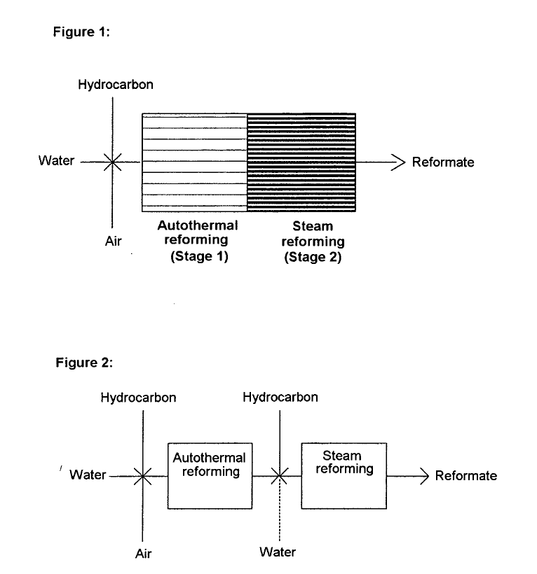

FIG. 1: Basic structure of the apparatus for the two-stage catalytic reforming of hydrocarbons

FIG. 2: Basic structure of the apparatus for the two-stage catalytic reforming with separate addition of hydrocarbons or water before the second stage

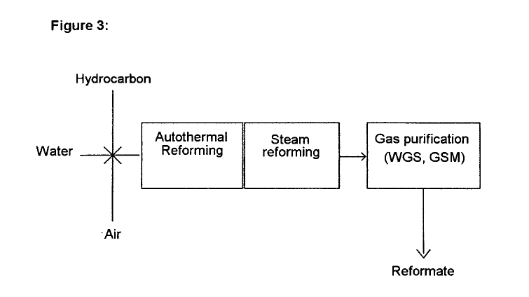

FIG. 3: Basic structure of the gas production system of the invention comprising two-stage catalytic reforming and a subsequent gas purification stage (WGS stage or gas separation membrane (GSM))

In a preferred embodiment, the reactor apparatus of the invention comprises two stages (ATR stage and SR stage) which contain two monolithic supports comprising metal or ceramic and are arranged directly after one another. These support bodies can be coated with different catalysts (cf. FIG. 1).

However, it is also possible to use a single monolithic support body which has two segments which are coated with different catalysts.

In a further preferred embodiment (cf. FIG. 2), the two reactors are connected in series, with a device for introducing hydrocarbon and/or oxygen being installed in the space in between. The introduction can, for example, be effected by means of nozzles or injectors.

FIG. 3 shows the gas production system of the invention comprising the two-stage catalytic reforming reactor and a downstream gas purification stage which can be based on one or more water gas shift stages (e.g. high-temperature WGS, low-temperature WGS or combinations thereof) or on a gas separation membrane (e.g. membranes made of palladium alloys). In the case of a subsequent purification of the fuel gas by means of a gas separation membrane, a further process stage for removing carbon monoxide to contents below 100 ppm of CO is generally no longer necessary. If the fuel gas is purified in a subsequent water gas shift stage (WGS stage), a further reduction in the carbon monoxide content to values below 100 ppm of CO can, for example, be effected, for example, by means of a PrOx reactor (PrOx=preferential oxidation).

To achieve quick start-up of the overall gas production system, the feed mixture can also be preheated electrically for a short time. The low thermal mass of the catalysts advantageously leads to fuel gas production commencing after only a few seconds.

Catalysts containing noble metals are preferably required for the two-stage reforming process of the invention. The catalyst for the autothermal reforming (ATR stage) comprises, for example, a support body and a catalyst composition which contains noble metals and has been applied in the form of a coating to the geometric surfaces of the support body. Preference is given to using platinum and/or rhodium as active phases; Pd-containing catalysts are also possible. Examples are catalysts comprising from 0.1 to 5% by weight of platinum on aluminium oxide and/or from 0.1 to 5% by weight of rhodium on aluminium oxide. Preferred support bodies are monolithic honeycomb bodies comprising ceramic or metal, open-celled ceramic or metal foams, metal sheets or irregularly shaped components. The total thickness of the catalytic coating is generally in the range from 20 to 200 μm. In the case of a multilayer coating, the catalyst composition can comprise not only a lower catalyst layer but also a second, upper catalyst layer, with the two layers being able to contain different platinum group metals.

The steam reforming of the residual hydrocarbons in the second stage of the reactor (SR stage) is likewise carried out using catalysts containing noble metals. Catalysts containing at least one of the noble metals from the group consisting of Au, Pt, Rh, for example, are possibilities here. Preference is given to using a catalyst comprising from 0.1 to 5% of Rh on aluminium oxide, if desired with additions of gold and/or platinum. It is here also possible in principle to use multilayer catalyst coatings, for example coatings comprising Au and Rh; comprising Au, Pt and Rh or comprising Au and Pt.

In general, the noble metals are used in the form of supported catalysts in which the noble metal is finely dispersed on an oxidic support material. Possible oxidic support materials for the platinum group metals are oxides from the group consisting of aluminium oxide, silicon dioxide, titanium dioxide and mixed oxides thereof and zeolites. Preference is given to using materials having a specific surface area of greater than 10 m²/g in order to make a very fine dispersion of the catalytically active components on this large surface area possible. The techniques for producing such a supported catalyst and for coating an inert support body therewith are known to those skilled in the art.

To increase the thermal stability of the catalyst composition, it can additionally contain at least one oxide selected from the group consisting of boron oxide, bismuth oxide, gallium oxide, oxides of the alkali metals, oxides of the alkaline earth metals, oxides of the transition elements and oxides of the rare earth metals in a concentration of up to 40% by weight, based on the total weight of the catalyst composition. The catalyst layers can additionally contain cerium oxide to reduce the formation of carbon deposits and to increase the sulphur resistance.

The gas production system of the invention can be operated using aliphatic hydrocarbons (methane, propane, butane, etc.), aromatic hydrocarbons (benzene, toluene, xylene, etc.), hydrocarbon mixtures (e.g. natural gas, petroleum spirit, heating oil or diesel oil) or alcohols (e.g. ethanol). Depending on the hydrocarbon used, it can be operated at steam/carbon ratios S/C of from 0.7 to 5. The air index λ of the feed mixture and its preheating temperature are selected so that a temperature in the range from 600 to 800° C., preferably 650° C., is established at the outlet of the first ATR stage.

The gas production system proposed or the apparatus can be used for obtaining hydrogen or hydrogen-containing mixtures for mobile and stationary fuel cells.

The following examples illustrate the subject matter of the invention.

### EXAMPLE 1

A mixture of isooctane and toluene (each 50% by weight) is reformed by the process of the invention in a two-stage reactor (comprising an ATR stage and an SR stage, construction as shown in FIG. 1). The reactor inlet temperature of the ATR stage is 400° C., the air stoichiometry (λ value) is 0.3 and the S/C value is 3. The space velocity (“SV”) of the reaction is set to SV=150 000 l/h, so that incomplete conversion of the hydrocarbons occurs. In steady-state operation, the reformate after passing through the first stage contains a proportion of about 5% by volume of residual hydrocarbons; the temperature of the reformate mixture at the outlet of the ATR stage is 650° C. A monolith having a cell density of 62 cells/cm² (400 cpsi) and a volume of 35 cm³ is used as catalyst for the ATR stage. The catalytic coating comprises a rhodium/aluminium oxide supported catalyst and has been applied to the honeycomb body in a concentration of 150 gram per litre. The coating concentration of the rhodium is 1 g/l (=0.67% by weight of Rh).

The reformate is introduced at 650° C. into the second stage (SR stage). A monolith which has 186 cells/cm² (1200 cpsi) and a volume of 140 cm³ and has been coated with a rhodium/aluminium oxide supported catalyst is used as catalyst for the SR stage. The coating concentration of the catalyst is 150 g/l, the coating concentration of the rhodium is 3 g/l (=2% by weight of Rh). The temperature at the outlet from the second stage is 450° C.

The hydrogen concentration of the reformate is 40% by volume, and the CO concentration is 8% by volume. The reformate produced in this way thus has a high hydrogen concentration and is fed directly into an WGS reactor. In this high-temperature shift stage, the CO content of the fuel gas is reduced further.

### EXAMPLE 2

A mixture of isooctane and toluene (each 50% by weight) is reformed by the process of the invention in a two-stage reactor (comprising an ATR stage and a separate SR stage as shown in FIG. 2). The reactor inlet temperature of the ATR stage is 400° C., the air stoichiometry (λ value) is 0.3 and the S/C value is 3. The space velocity (SV) of the reaction is set to SV 50 000 l/h. A mixture of isooctane/toluene (1:1) is introduced by means of an injector nozzle located between the two reactors. The amount introduced is set so that a hydrocarbon content of 3% by volume is obtained in the reformate gas upstream of inlet into the (second) SR stage.

A monolith having a cell density of 62 cells/cm² (400 cpsi) and a volume of 70 cm³ is once again used as catalyst for the ATR stage. It has been coated with a supported catalyst comprising 0.67% by weight of rhodium on aluminium oxide. The temperature of the gas mixture at the outlet of the ATR stage is 630° C. A monolith which has 1200 cpsi and a volume of 140 cm³ and has been coated with a supported catalyst comprising 2% by weight of rhodium on aluminium oxide is used as catalyst for the SR stage. The coating concentration of the catalyst is 150 g/l, and that of rhodium is 3 g/l. The temperature at the outlet of the SR stage is 440° C. and the hydrogen concentration of the reformate is 40.5% by volume, and the CO concentration is 7.5% by volume. The reformate produced in this way has a high hydrogen concentration and is fed directly into a membrane reactor (based on a Pd gas separation membrane). In this reactor, the CO content of the fuel gas is reduced to such an extent that it can be fed directly into a PEM fuel cell.

### COMPARATIVE EXAMPLE CE1

The single-stage standard process for autothermal reforming is employed to demonstrate the improvements achieved by the two-stage process of the invention.

A mixture of isooctane and toluene (each 50% by weight) is reformed by the standard process (described in EP 1 157 968 A1, Example 1) in a single-stage reactor. The reactor inlet temperature of the ATR stage is 500° C., the air stoichiometry (lambda value) is 0.3 and the S/C value is 1.5. The space velocity (SV) of the reaction is set to SV=30 000 l/h. A monolith having a cell density of 62 cells/cm² (400 cpsi) and a volume of 35 cm³ is used as catalyst for the ATR stage. The catalytic coating consists of a rhodium/aluminium oxide supported catalyst and has been applied in a concentration of 150 gram per litre to the honeycomb body. The coating concentration of the rhodium is 1 g/l (=0.67% by weight of Rh). The temperature of the reformate mixture leaving the catalyst is 680° C. The reformate contains (in addition to nitrogen and carbon dioxide) 36% by volume of hydrogen and 12% by volume of carbon monoxide. The reformate produced thus has a lower hydrogen concentration and additionally has to be cooled to 450° C. by means of a heat exchanger before being introduced into the WGS stage. Only then can it be fed into the high-temperature shift stage of the gas production system. The superiority of the process of the invention can be seen.

1. Process for producing hydrogen-containing fuel gases for fuel cells by catalytic reforming of hydrocarbons and subsequent gas purification, wherein the catalytic reforming has two successive stages of which the first stage comprises autothermal reforming and the second stage comprises downstream steam reforming at temperatures below 650° C.

2. Process according to claim 1, characterized in that the catalytic reforming is carried out adiabatically and the reformate mixture at the outlet from the first stage of autothermal reforming has a temperature of from 650 to 850° C.

3. Process according to claim 1, characterized in that the reformate mixture at the outlet from the second stage of steam reforming has a temperature of from 400 to 650° C.

4. Process according to claim 1, characterized in that the reformate mixture at the outlet of the autothermal reforming stage has a residual hydrocarbon content of from 0.5 to 10% by volume.

5. Process according to claim 1, characterized in that catalysts comprising support bodies to which supported catalysts containing noble metals have been applied are used for both stages.

6. Process according to claim 5, characterized in that one or more noble metals from the group consisting of rhodium, platinum and palladium immobilized on oxidic support materials are used as catalysts for the autothermal reforming and one or more noble metals from the group consisting of gold, rhodium and platinum immobilized on oxidic support materials are used as catalysts for the steam reforming.

7. Process according to claim 1, characterized in that the fuel gas after the two-stage reforming is passed directly without interposition of one or more heat exchangers to a gas purification stage.

8. Process according to claim 1, characterized in that the gas purification stage comprises one or more water gas shift stages or one or more gas separation membranes.

9. Apparatus for producing hydrogen-containing fuel gases for fuel cells by catalytic reforming of hydrocarbons and subsequent gas purification, comprising two successive reactor stages for catalytic reforming, with the first reactor stage having at least one catalyst for autothermal reforming and the second reactor stage having at least one catalyst for steam reforming and no heat exchanger being installed between the second reactor stage and the gas purification stage.

10. A mobile or stationary fuel cell in which the process of claim 1 is used.

11. A mobile or stationary fuel cell in which the apparatus of claim 9 is used.
